(19) United States
(12) Patent Application Publication
(10) Pub. No.: US 2016/0342950 A1
(43) Pub. Date: Nov. 24, 2016

(54) METHOD AND SYSTEM FOR ANTICIPATORY MEETING ROOM SCHEDULING

(71) Applicant: Cisco Technology, Inc., San Jose, CA (US)

(72) Inventors: Carlos M. Pignataro, Raleigh, NC (US); James D. Stanley, III, Austin, TX (US); Rajesh Vargheese, Austin, TX (US)

(21) Appl. No.: 14/719,412

(22) Filed: May 22, 2015

(51) Int. Cl. G06Q 10/10

(52) U.S. Cl. CPC G06Q 10/1095

(57) ABSTRACT

Techniques are presented herein for scheduling meeting rooms for participants by a server in communication with user devices. The server receives a meeting trigger signifying a necessity for scheduling of a meeting. The server then determines that a meeting room is needed for the meeting. After determining that a meeting room is needed, the server queries the plurality of meeting rooms located within a proximity of the first user for characteristics of the meeting rooms. The server then filters a subset of the plurality of meeting rooms based on a set of constraints for the meeting. Any rooms whose characteristics do not meet the constraints are filtered out of the plurality of meeting rooms. The subset of the plurality of meeting rooms are then sorted based on their usage state. The server then reserves one of the meeting rooms from the subset for the meeting between the participants.

### TECHNICAL FIELD

The present disclosure relates to scheduling meeting rooms, and more specifically, anticipating the need for a meeting room and scheduling a meeting room that is best suited for the participants of a meeting.

### BACKGROUND

Scheduling or calendaring services are utilized by many users to schedule meetings, conferences, and gatherings between participants. One of the features of a scheduling service is to schedule a meeting room in which the meeting will take place if the meeting requires the use of a meeting room. Many office buildings have multiple meeting or conference rooms available for employees to use for meetings or conferences with other participants. These meeting rooms may differ in their characteristics, such as the size of the room, location of the room in relation to the scheduled participants, availability of Wi-Fi® wireless connectivity in the room, availability of video conferencing capabilities in the room, etc. Meeting rooms may also be virtual meeting rooms, that is, a meeting hosted by a web-based meeting service.

### BRIEF DESCRIPTION OF THE DRAWINGS

FIG. 1 is a schematic block diagram of an environment for anticipatorily scheduling a meeting room, according to an example embodiment.

FIG. 2 is a block diagram of a server illustrated in FIG. 1, wherein the server is configured to perform anticipatory meeting scheduling, in accordance with an example embodiment.

FIG. 3 is a table indicating the scheduled and occupancy state of a meeting room, along with the status priority of the meeting room, according to an example embodiment.

FIG. 4 is a flow diagram of a method for determining the meeting room to be scheduled, according to an example embodiment.

FIG. 5 is a flow diagram of a method for scheduling a meeting room for an existing meeting invite, according to an example embodiment.

FIG. 6 is a flow diagram of a method for scheduling a meeting room for an impromptu meeting, according to an example embodiment.

FIG. 7 is a flowchart depicting a process for anticipatorily scheduling a meeting room, according to an example embodiment.

### DESCRIPTION OF EXAMPLE EMBODIMENTS

### Overview

Despite scheduling services aiding participants in scheduling meeting rooms for meetings, the current scheduling services contain flaws. Scheduling services only present the meeting rooms that are available for specific dates and times to the participants when scheduling a meeting. Thus, especially in environments where meetings are frequent, or environments with a lack of adequate available meeting rooms, in order to acquire a desired room for a meeting, participants are required to schedule the meeting rooms well in advanced to avoid the desired meeting room not being available. In addition, participants scheduling the meeting typically need knowledge of the characteristics of all of the meeting rooms in order to determine which room is best suited for the meeting. For example, if knowledge of the characteristics of the meeting rooms are not known, and video conferencing is needed for a meeting but video conferencing is not available in the scheduled meeting room, the participants may not discover that the scheduled meeting room does not have the necessary video conferencing capabilities until the participants arrive at the meeting room for their scheduled meeting. This could result in the meeting not being able to take place.

Moreover, current scheduling services only track whether or not a meeting room is scheduled for a specific date and time. The scheduling services do not take into account the current occupancy of the room when scheduling meeting rooms, specifically when scheduling last minute meetings. For example, while meeting rooms are often scheduled in advanced, these meeting rooms are sometimes never used for the scheduled meeting, either because the meeting has been canceled without un-scheduling the meeting room via the scheduling service, or the location of the meeting has been changed without making these changes via the scheduling service. In addition, scheduled meetings often run short of their projected time span, leaving the meeting room scheduled but unused for the remainder of the scheduled time slot. Thus, it is not uncommon for a meeting room to be scheduled for a first set of participants, but the meeting room is not being used by the first set of participants. Meanwhile, a second set of participants looking to schedule a last minute meeting cannot use the scheduled but unused meeting room, and are unaware that the scheduled and unused meeting room is unoccupied.

Furthermore, participants often fail to utilize scheduling services to schedule meeting rooms. Instead, these participants host impromptu meetings in any meeting room that they discover is unused. Thus, when scheduling a last minute meeting in a meeting room via a scheduling service, participants may find that other participants are conducting a meeting in the meeting room scheduled via the scheduling service. This requires the participants who scheduled the meeting room to then either quickly find another room for the meeting or to confront the group of participants already in the meeting room to request that those participants leave.

Techniques are presented for scheduling meeting rooms for participants by a server in communication with user devices that are utilized by the participants. The server receives a meeting trigger that signifies a necessity for, or a scheduling of, a meeting in which a first user is a participant. The server then determines that a meeting room is needed for the meeting. Upon determining that a meeting room is needed for the meeting, the server queries the data associated with a plurality of meeting rooms located within a predetermined proximity of the first user for characteristics of the plurality of meeting rooms. Once the meeting rooms within a proximity of the user devices are identified and the characteristics of each of these rooms are determined, the server then filters a subset of the plurality of meeting rooms based on a set of constraints for the meeting. Thus, any rooms whose characteristics do not meet the constraints needed for the meeting room is filtered out of the plurality of meeting rooms. The subset of the plurality of meeting rooms are then sorted based on the status of the subset of the plurality of meeting rooms in terms of the rooms being scheduled and the rooms being occupied. The server then reserves one of the meeting rooms from the subset of the plurality of meeting rooms for the meeting between the participants.

The anticipatory meeting scheduling system and method presented herein enable users to schedule meeting rooms based on energy data and meeting needs for the participants of the meeting. In addition, the anticipatory meeting scheduling system may anticipate the need for a meeting room prior to a user attempting to schedule a meeting room, and schedule a meeting room based on energy data and meeting needs for the participants of the meeting. The anticipatory meeting scheduling system analyzes data sets relating to location, wireless network usage in the rooms, energy usage in the rooms, current scheduling data for the meeting rooms, etc., in order to schedule the appropriate room for the participants of the meeting. The anticipatory meeting scheduling system may determine if a meeting room is available even if an online directory says the meeting room is not available. Furthermore, the system may provide suggestions to a participant or the participants of the room availability.

### Example Embodiments

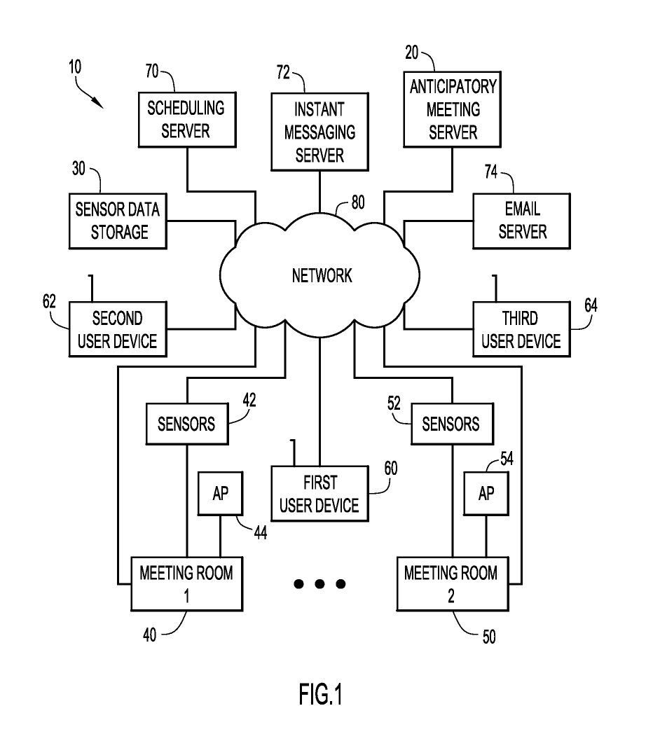

An example embodiment of an anticipatory meeting scheduling system 10 is depicted in FIG. 1. The anticipatory meeting scheduling system 10 is a system that contains an anticipatory meeting server 20, a sensor data storage 30, a plurality of meeting rooms 40, 50, and may contain a first user device 60, a second user device 62, and a third user device 64. Furthermore, each of the rooms 40, 50 illustrated include a set of sensors 42, 52 and a wireless network (e.g., Wi-Fi®) access point (AP) 44, 54. It is noted that the APs 44 and 54 need not be within the respective meeting rooms 40 and 50, but may instead be placed in hallways near the meeting rooms. Also, it is possible that there are more or fewer APs having a coverage area that includes meeting rooms 40 and 50. The anticipatory meeting scheduling system 10 further includes a scheduling server 70, an instant messaging server 72, and an email server 74. Each of the devices of the anticipatory meeting scheduling system 10 is capable of communicating over the network 80. The scheduling server 70 may be configured to enable the user devices 60, 62, 64 to operate scheduling services that allow the participants of the user devices 60, 62, 64 to schedule meetings with one another. In addition, the scheduling server 70 may provide meeting reminders to the user devices 60, 62, 64 to reminder the participants of the user devices 60, 62, 64 of an upcoming meeting. The instant messaging server 72 may be configured to enable the user devices 60, 62, 64 to operate instant messaging services that allow the user devices 60, 62, 64 to transmit real-time text messages to one another across the network 80. The email server 74 may be configured to enable the user devices 60, 62, 64 to operate email services that allow electronic mail to be received and sent from the user devices 60, 62, 64 over the network 80.

The sensor data storage 30 stores the data acquired by the sensors 42, 52 from each of the rooms 40, 50. The anticipatory meeting scheduling system 10 is configured to analyze activity associated with each user device 60, 62, 64 to determine if a meeting room is necessary for a meeting, identify the meeting rooms 40, 50 within a proximity of the user devices 60, 62, 64, determine whether these meeting rooms 40, 50 are occupied via data collected by the sensors 42, 52, to provide the user devices 60, 62, 64 with the most suitable meeting room for the meeting. The system 10 may also provide directions for each user to a meeting room from the current location of the user devices 60, 62, 64.

The anticipatory meeting server 20 of the anticipatory meeting scheduling system 10 is configured to host and support the exchange of data between user devices 60, 62, 64, meeting rooms 40, 50, and the sensor data storage 30. Some examples of user devices 60, 62, 64 includes any type of computing device including, without limitation, personal computer (PC) devices, such as stationary (e.g., desktop) computers, laptop computers, or any other type of mobile computing device such as cellular (smart) mobile phones (e.g., cell phones, also referred to as mobile phones), note pads, tablets, personal data assistant (PDA) devices, and other portable media devices. The user devices 60, 62, 64, the anticipatory meeting server 20, and other devices of the anticipatory meeting scheduling system 10 can utilize any suitable operating system to facilitate the sharing of location data and meeting room sensor data between the various meeting rooms 40, 50, the sensor data storage 30, and the user devices 60, 62, 64 with the anticipatory meeting server 20. In addition, the techniques described herein for anticipating and scheduling meeting rooms via the anticipatory meeting scheduling system 10 can be integrated with any suitable type of commercial software products and scheduling or calendaring services, which may be provided by the scheduling server 70, the instant messaging server 72, and the email server 74.

The anticipatory meeting scheduling system 10 facilitates the exchange of data between meeting rooms 40, 50, user devices 60, 62, 64, and/or one or more servers 20, 70, 72, 74 via any one or more suitable networks 80 including, without limitation, any one or more of local or wide area networks, Internet Protocol (IP) networks such as intranet or internet networks, telephone networks (e.g., public switched telephone networks), wireless or mobile phone or cellular networks, and any suitable combinations thereof. The number of user devices 60, 62, 64, meeting rooms 40, 50, and server 30 depicted in FIG. 1 is for example purposes only, and it is noted that the network(s) 80 connecting the user device(s) 60, meeting rooms 40, 50, and server 30 can support communications and exchange of data between any number of user devices, meeting rooms, and servers.

As previously explained, the meeting rooms 40, 50 of the anticipatory meeting scheduling system 10 may include sensors 42, 52. The sensors 42, 52 may include, but are not limited to, a motion sensor, a sensor for detecting the wireless network (e.g., Wi-Fi) usage in the meeting room 40, 50, a sensor for detecting the energy usage in a meeting room 40, 50, a sensor for detecting whether or not the phone is being used in a meeting room 40, 50, a sensor for detecting whether or not the video conferencing equipment is being used in a meeting room 40, 50, etc. Each of the rooms 40, 50 may include any number of such sensors 42, 52, or no sensors 42, 52 at all. The sensors 42, 52 of the meeting rooms 40, 50 may collect data related their respective rooms. Thus, the sensors 42 installed in meeting room 40 collect data regarding meeting room 40, while the sensors 52 installed in meeting room 50 collect data regarding meeting room 50. Furthermore, the collected data from the sensors may be sent to the sensor data storage 30. As illustrated in FIG. 1, the sensors 42, 52 send the collected data to the sensor data storage 30 via the network 80. As explained previously, the network 80 may be a wired or a wireless network.

The sensor data storage 30 stores data from each of the sensors 42, 52. The sensor data storage 30 may be any type of tangible storage device that can retain and store sensor data for use by the anticipatory meeting server 20 and any other device of the anticipatory meeting scheduling system 10. The sensor data storage 30 may be, for example, but is not limited to, an electronic storage device, a magnetic storage device, an optical storage device, an electromagnetic storage device, a semiconductor storage device, or any suitable combination of the foregoing. A non-exhaustive list of more specific examples of the sensor data storage 30 includes: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device. The sensor data storage 30 is configured to store any files or data recorded by the sensors 42, 52. Thus, the sensor data storage 30 may store real-time sensor data values that represent the perceived conditions of a meeting room 40, 50 by the sensors 42, 52 in real-time. The sensor data storage 30 may also store historical data of the conditions of a meeting room 40, 50 that were detected by the sensors 42, 52. The sensor data storage 30 may record the conditions present in a meeting room 40, 50 at all times, including when the rooms 40, 50 are occupied and when the rooms 40, 50 are unoccupied. This historical sensor data of the meeting rooms 40, 50 may enable the anticipatory meeting server 20 of the anticipatory meeting scheduling system 10 to compare real-time sensor data with the historical data to determine if the meeting rooms 40, 50 are currently occupied.

Furthermore, as previously explained, each of the meeting rooms 40, 50 may or may not include an AP 44, 54. AP 44, 54 may be any device that routes wireless data between the devices and the network 80 of the system 10 or to another network. AP 44, 54 may include an antenna, a processor, and a memory. In one example, an AP is able to support Wi-Fi in general, and the 802.11a, 802.11b, 802.11g, 802.11n, and/or 802.11ac wireless networking standards in particular. The APs 44, 54 may be configured to relay the data detected by the sensors 42, 52 of a meeting room 40, 50 to the network 80, and ultimately to the sensor data storage 30. The APs 44, 54 may also be configured to relay location data to the server 20 of both the user devices 60, 62, 64 and the meeting rooms 40, 50 in relation to the user devices 60, 62, 64 and vice versa. The anticipatory meeting server 20 may utilize location-based services supported by the APs 44, 54 to track the physical location of user devices 60, 62, 64. Additionally, the APs 44, 54 may be configured to provide wireless network access to the user devices 60, 62, 64 once located within and/or around a meeting room 40, 50.

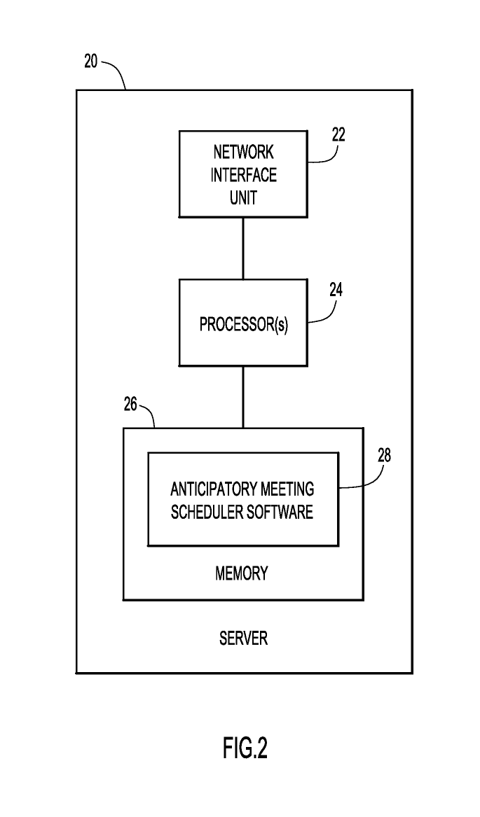

Illustrated in FIG. 2 is an example block diagram of the anticipatory meeting server 20. The anticipatory meeting server 20 may be configured to perform the techniques presented herein. The anticipatory meeting server 20 includes a network interface unit 22, a processor(s) 24, and a memory 26. The network interface unit 22 is configured to enable network communications over a network. While conceptually illustrated as a ‘network interface unit,’ it will be appreciated that a physical device may contain more than one network interface unit or type of interface to communicate with other devices within a network. For example, network interface unit 22 may comprise a wireless transceiver to facilitate wireless communication over network 80 illustrated in FIG. 1.

The processor(s) 24 may be embodied by one or more microprocessors or microcontrollers, and executes software instructions stored in memory 26 for anticipatory meeting scheduler software 28 in accordance with the techniques presented herein in connection with FIGS. 1, 3-7.

Memory 26 may include one or more computer readable storage media that may comprise read only memory (ROM), random access memory (RAM), magnetic disk storage media devices, optical storage media devices, flash memory devices, electrical, optical, or other physical/tangible memory storage devices.

Thus, in general, the memory 26 may comprise one or more tangible (e.g., non-transitory) computer readable storage media (e.g., a memory device) encoded with software comprising computer executable instructions, and when the software is executed by the processor(s) 24, the processor(s) 24 is operable to perform the operations described herein in connection with the anticipatory meeting scheduler software 28. In other approaches, anticipatory meeting scheduler software 28 is stored remotely, external to the anticipatory meeting server 20, but accessible by the processor(s) 24.

The functions of the processor(s) 24 may be implemented by logic encoded in one or more tangible computer readable storage media or devices (e.g., storage devices compact discs, digital video discs, flash memory drives, etc. and embedded logic such as an ASIC, digital signal processor instructions, software that is executed by a processor, etc.).

While FIG. 2 shows that the anticipatory meeting server 20 may be embodied as a dedicated physical device, it should be understand that the functions of the anticipatory meeting server 20 may be embodied as software running in a data center/cloud computing system, together with numerous other software applications.

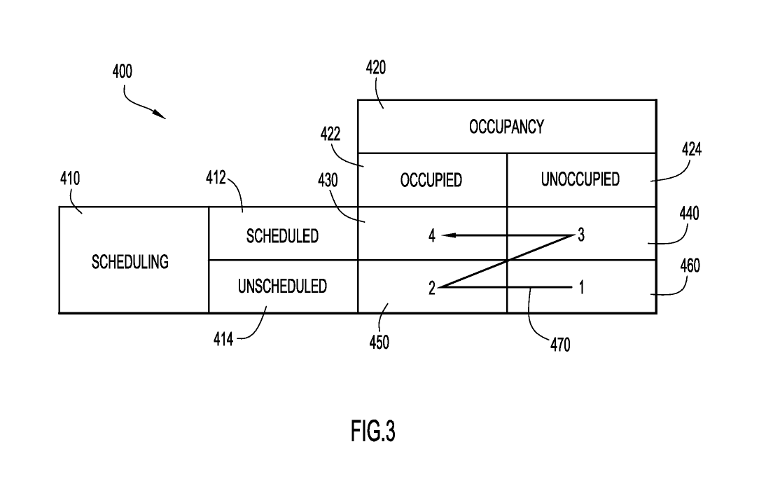

Illustrated in FIG. 3, a table representing the multiple different “states” in which a meeting room 40, 50 may be labeled according to the techniques presented herein. Each meeting room has a static state and a dynamic state. The static state of a meeting room is the scheduling state 410 of the meeting room, while the dynamic state of a meeting room is the occupancy state 420 of the meeting room. The scheduling state 410 of a meeting room represents the reservation or scheduling of a meeting room through a scheduling or calendaring service. The scheduling state 410 of a meeting room may be either scheduled as shown at 412, or unscheduled as shown at 414. The occupancy state 420 of a meeting room represents whether or not people are currently in the meeting room. The occupancy state 420 of a meeting room may be either occupied as shown at 422, or unoccupied as shown at 424. Thus, a meeting room may be labeled with one of four different usage states, where each state is a combination of a scheduling state 410 and an occupancy state 420. A meeting room may be unscheduled and unoccupied 460, unscheduled and occupied 450, scheduled and unoccupied 440, and scheduled and occupied 430. A meeting room having a usage state of unscheduled and unoccupied 460 means that the meeting room is currently not scheduled through a scheduling service, and people are not currently in the meeting room. A meeting room that has a usage state of unscheduled and occupied 450 means that the meeting room is currently not scheduled through a scheduling service, but people are currently located inside the meeting room. A meeting room having a usage state of scheduled and unoccupied 440 means that the meeting room has been scheduled through a scheduling service, but people are not in the meeting room despite the meeting room being scheduled. Finally, a meeting room 40, 50 having a usage state of scheduled and occupied 430 means that the meeting room has been scheduled through a scheduling service, and people are in the meeting room.

FIG. 3 also illustrates an arrow 470 that follows a path of the most preferred room usage state to the least preferred room usage state. The arrow 470 may represent a meeting room usage state priority. According to the table illustrated in FIG. 3, a meeting room having the state of unscheduled and unoccupied 460 is the most preferred usage state in terms of its available for use, followed by the unscheduled and occupied usage state 450. The third most preferred usage state is scheduled and unoccupied 440, while the least preferred meeting room usage state is scheduled and occupied 430. A meeting room that has a usage state of unscheduled and unoccupied 460 is the most preferred status for a meeting room because the meeting room has not been scheduled for use through a scheduling service, and the meeting room is not being used by other people. Thus, when in usage state 460, the meeting room is completely free to be used. In the event a meeting room has the unscheduled and occupied usage state 450, the meeting room may be used by the participants of the meeting, but the people inside of the meeting room will need to be “kicked-out”, or removed from, the meeting room. A meeting room having the scheduled and unoccupied usage state 440 is preferred less than the unscheduled and occupied usage state 450 the scheduled and unoccupied usage state 440 means that a group of people have already claimed that meeting room through a scheduling service, and are thus expecting that the meeting room is available for them to use. Conversely, people who are using a meeting room without going through the proper channels to reserve the meeting room do not have an expectation that the meeting room they are using would stay unscheduled for an indefinite period of time. In the even that the most suitable meeting room available has the scheduled and unoccupied usage state 440, the meeting room is available to be scheduled if a preemptive mechanism is available for the meeting to be scheduled, such as, the priority of the meeting to be scheduled having a greater priority than the priority of the meeting that is scheduled for the meeting room. Finally, if a meeting room has the scheduled and occupied usage state 430, that meeting room cannot be used for the meeting.

The occupancy of each meeting room 40, 50 may be determined from a number of sensors 42, 52 that provide information and/or data to the sensor data storage 30 via network 80. The information and/or data may be accessed on the sensor data storage 30 by the anticipatory meeting server 20. For example, one of the sensors 42, 52 in the meeting rooms 40, 50 may be a motion sensor, which is capable of detecting movement within the meeting room 40, 50 in which the motion sensor is installed. The meeting rooms 40, 50 may be equipped with another sensor that enables the anticipatory meeting server 20 to monitor the wireless network (e.g., Wi-Fi) usage in the meeting room. In addition, each meeting room 40, 50 may be equipped with a sensor 42, 52 that enables the anticipatory meeting server 20 to monitor and/or control the power consumption in the meeting room 40, 50. Each meeting room 40, 50 may also be equipped with a sensor or sensors 42, 52 that enables the anticipatory meeting server 20 to monitor whether or not the phone and/or the video conferencing equipment is being used in a meeting room 40, 50. Occupancy of a meeting room 40, 50 may be determined by analyzing data obtained by one of the sensors 42, 52, or by combining the data from multiple ones of the sensors 42, 52 with each sensor 42, 52, based on weighting mechanism. For example, the anticipatory meeting server 20 may apply a weighting mechanism according to the equation, Occupancy =E (Motion_Sensor +Average(Wi-Fi_Use_in_Room/Max_Wi-Fi; Energy_Use_in_Room/Max_Energy; phone_use? 1:0; video_use? 1:0)), where the average determines or represents the average number of people in the meeting room.

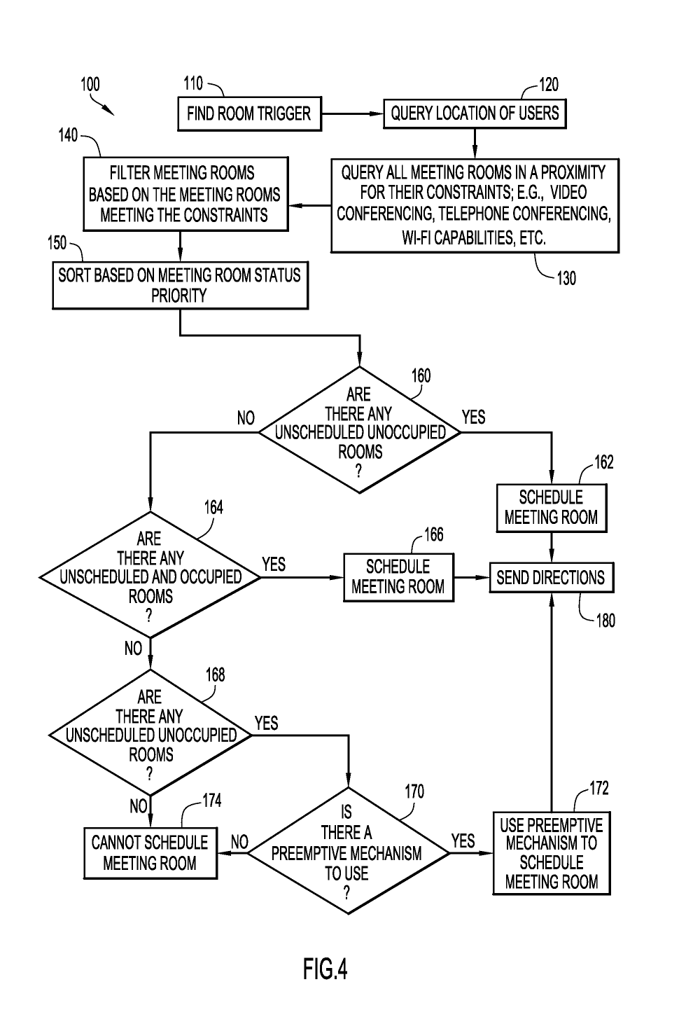

Turning now to FIG. 4, illustrated is a flow diagram of a find room method performed by the anticipatory meeting scheduler software 28 of the anticipatory meeting server 20 of the anticipatory meeting scheduling system 10. Reference is also made to FIGS. 1 and 3 for purposes of the description of FIG. 4. The find room method is configured to determine the most suitable meeting room for a plurality of users based on a variety of parameters. Operation of the find room algorithm begins at 110, where the anticipatory meeting server 20 receives a find room trigger, such as a scheduled meeting, or an impromptu meeting. The find room trigger may contain information regarding the participants of the meeting, the constraints needed for the meeting room (i.e., video conferencing capabilities, telephone conferencing capabilities, wireless network (e.g., Wi-Fi) capabilities, size of the room, proximity of the room, etc.), the time and date of the meeting, the importance or significance of the meeting, and/or the urgency of the meeting. At block 120, the server anticipatory meeting 20 then queries the locations of all the user device(s) of users to be participating in the meeting and the proximity of those user devices to various meeting rooms 40, 50. As previously explained, this can be accomplished by the APs 44, 54 relaying location data to the anticipatory meeting sever 20 of both the user devices 60, 62, 64 and the meeting rooms 40, 50 in relation to each other. As illustrated in FIG. 1, the participants of the first user device 60 and the second user device 62 are located closer to meeting room 40 than to meeting room 50, while the participant of the third user device 64 is located closer to meeting room 50, than to meeting room 40. Once the anticipatory meeting server 20 determines the location of the user devices 60, 62, 64, at step 130, the anticipatory meeting server 20 queries all of the meeting rooms within a certain proximity of the user devices 60, 62, 64 for their constraints and/or capabilities. In the example embodiment illustrated in FIG. 1, both meeting room 40 and meeting room 50 are within a certain proximity of the user devices 60, 62, 64, and thus both meeting rooms 40, 50 will be queried. The constraints of a meeting room 40, 50, as explained previously, include, but are not limited to, video conferencing capabilities, telephone conferencing capabilities, wireless network capabilities, size of the room, proximity of the room, etc. At block 140, the anticipatory meeting server 20 then filters the list of the meeting rooms by eliminating or discarding candidate meeting rooms that do not contain features or capabilities, such as, video conferencing capabilities, that are a necessity for the meeting. In other words, only one or more meeting rooms that have certain features or capabilities that are required for the meeting of the participants are then remaining after the filtering step.

At step 150, the anticipatory meeting server 20 then sorts the remaining meeting rooms based on the meeting room usage state priority, as described previously in connection with FIG. 3. The anticipatory meeting server 20 sorts the remaining meeting rooms based on the meeting room usage state priority by the anticipatory meeting server 20 first determining, at step 160, if any of the meeting rooms have a state of unscheduled and unoccupied usage state 460, which is the most preferred meeting room to schedule. As previously stated, the anticipatory meeting server 20 may access sensor data that is stored on the sensor data storage 30, or may access the sensors 40, 50 to determine if the meeting rooms 40, 50 are occupied. In addition, the anticipatory meeting server 20 may store data as to who has scheduled the meeting rooms via a scheduling service. If a meeting room has a usage state of unscheduled and unoccupied 460, at step 162 the anticipatory meeting server 20 will scheduled that meeting room. If multiple meeting rooms have a usage state of scheduled and unoccupied 460, then the anticipatory meeting server 20 will schedule the meeting room that has a location that is most suitable for all of the participants of the meeting. Thus, as illustrated in the example of FIG. 1, if both meeting room 40 and meeting room 50 have a usage state of unscheduled and unoccupied 460, the anticipatory meeting server 20 will reserve meeting room 40 because the first user device 60 and the second user device 62 are located in closer proximity to meeting room 40 than meeting room 50, and thus, the majority of the user devices 60, 62, 64 are located in closer proximity to meeting room 40 than meeting room 50. However, if the majority of participants were located closer to meeting room 50 than to meeting room 40, the anticipatory meeting server 20 may reserve meeting room 50. At step 180, the anticipatory meeting server 20 then sends directions to the scheduled meeting room to the user devices 60, 62, 64 of each of the participants to assist the participants in finding the scheduled meeting room.

However, if a meeting room does not have a usage state of unscheduled and unoccupied 460, at step 164 the anticipatory meeting server 20 will then determine if there are any meeting rooms that have a usage state of unscheduled and occupied 450. As previously stated, the anticipatory meeting server 20 may access sensor data that is stored on the sensor data storage 30, or may access the sensors to determine if the meeting rooms are occupied. The anticipatory meeting server 20 may additionally access information stored on the anticipatory meeting server 20 to determine if the meeting rooms have been scheduled via the scheduling service. If a meeting room has a usage state of unscheduled and occupied 450, the anticipatory meeting server 20 then, at step 166, schedules the meeting room. If multiple meeting rooms have a usage state of unscheduled and occupied 450, then the anticipatory meeting server 20 will schedule the meeting room that has a location that is most suitable for the majority of the participants of the meeting, as explained previously. The anticipatory meeting server 20 may also take into consideration the number of people currently in the meeting rooms when determining which meeting room to reserve. At step 180, the anticipatory meeting server 20 then sends directions to the scheduled meeting room 40, 50 to the user devices 60, 62, 64 of each of the participants.

In the event that the anticipatory meeting server 20 determines that none of the remaining meeting rooms have a usage state of unscheduled and occupied 450, then at step 168, the anticipatory meeting server 20 determines if any of the remaining meeting rooms have a usage state of scheduled and unoccupied 440. If a meeting room has a usage state of scheduled and unoccupied 440, at step 170 the anticipatory meeting server 20 determines if there is a preemptive mechanism that may be used to schedule a meeting room that already is scheduled for another meeting. A preemptive mechanism is a mechanism or rule that allows the anticipatory meeting server 20 to reserve a meeting room that is already scheduled for another meeting. Thus, the preemptive mechanism allows the anticipatory meeting server 20 to un-schedule a previously scheduled meeting for a meeting room so that the same meeting room may be scheduled for the meeting to be scheduled. The preemptive mechanism may be based on the priority rating of each meeting, where one factor for determining the priority rating of the meeting may be the participants of the meeting and their role in the company. For example, a meeting between three lower level employees of a company will have a first priority rating, while the meeting between the chief executive officer (CEO) of the company and board of directors of the company will have a second priority rating, where the second priority rating is higher than the first priority rating because the CEO and the board of directors have a more important and higher role in the company than the lower level employees. In this example, the higher priority rating will provide the anticipatory meeting server 20 with a preemptive mechanism for scheduling a meeting room for the CEO and the board of directors over the previously scheduled meeting by the lower level employees. Other factors for determining the priority rating of the meeting may include, but are not limited to, the number of the participants of the meeting, the subject matter of the meeting, impeding deadlines for the participants of the meeting, etc. The priority rating of the meetings may be determined by the scheduling service, or by the anticipatory meeting server 20. If the meeting to be scheduled has a higher priority rating, then the anticipatory meeting server 20 may have a preemptive mechanism for rescheduling the currently scheduled meeting room to allow the use of the meeting room for meeting to be scheduled. Thus, a step 172, if a preemptive mechanism exists for scheduling the meeting to be scheduled over a meeting already scheduled for a meeting room, then the anticipatory meeting server 20 may use the preemptive mechanism for scheduling the meeting room. At step 180, the server may then send directions to the scheduled meeting room to the user devices 60, 62, 64 of each of the participants.

However, in the event that the meeting rooms do not have a unscheduled and unoccupied usage state 460, an unscheduled and occupied usage state 450, or a scheduled and unoccupied usage state 440, then the meeting rooms have a usage state of scheduled and occupied 430, and thus, at step 174, the meeting to be scheduled cannot be scheduled in any of the meeting rooms. In addition, if the anticipatory meeting server 20 determines that there are meeting rooms 40, 50 that have a usage state of scheduled and unoccupied 440, but the anticipatory meeting server 20 determines that there is no preemptive mechanism to use to schedule the meeting to be scheduled, then, at step 174, the meeting to be scheduled cannot be scheduled in any of the meeting rooms.

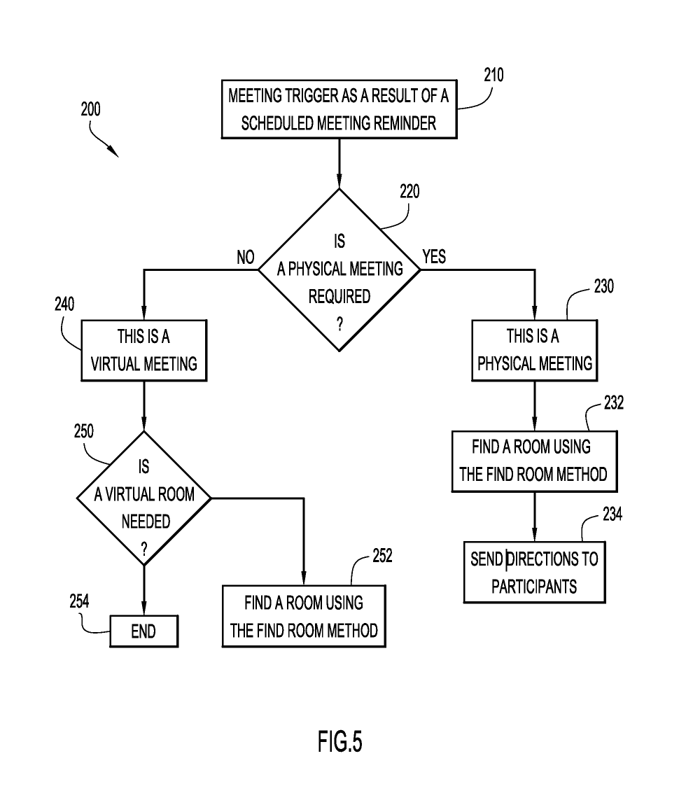

Turning to FIG. 5, illustrated is a flow diagram of a method for scheduling a meeting room for an existing scheduled meeting by the anticipatory meeting server 20 of the anticipatory meeting scheduling system 10. Often, meetings are scheduled via scheduling or calendaring software, but meeting rooms are not reserved for the meeting. In addition, when meetings are scheduled via the scheduling service, meeting reminders may be sent to the participants of the meeting (e.g., the participants may receive a meeting reminder from the scheduling service 15 minutes prior to the scheduled meeting time) or the calendar application on a user device may generate and display a reminder. When meeting reminders are generated and displayed by the user devices of the participants, the user device may send, simultaneously to generating and displaying the meeting reminder, the meeting trigger to the anticipatory meeting server 20. In addition, the anticipatory meeting server 20 may be monitoring the user devices, and when the user devices generate and display the meeting reminder, the anticipatory meeting server 20 may interpret the displaying of the meeting reminder as a meeting trigger. Furthermore, the user devices may be sent meeting reminders from the scheduling server 72, illustrated in FIG. 1, of the scheduling service. In this example, when the scheduling server 72 sends meeting reminders to the user devices of the participants of the meeting, the scheduling server 72 may simultaneously send a meeting trigger to the anticipatory meeting server 20. When the meeting reminders are sent to the participants of the meeting or a user device generates and displays a meeting reminder, the anticipatory meeting server 20 receives a meeting trigger that begins the process 200 of scheduling a meeting room. At step 210, the server receives a meeting trigger, which is in response to the receiving a meeting reminder from a user device of one the participants of a meeting. The anticipatory meeting server 20 then determines at step 220 if the meeting requires a physical meeting between the participants. The meeting reminder may include data or information useful for determining whether or not a meeting requires a physical meeting between the participants. For example, the meeting reminder may include a list of all of the participants of the meeting, and the anticipatory meeting server 20, using location-based services of the user devices 60, 62, 64 of the participants, may be able to determine the current locations of all of the participants. If all of the participants of the meeting are located in the same building, a physical meeting room will likely be needed for the meeting. However, if one or more of the participants are located in different locations that would make it difficult for each of the participants to meet with each other in person, a virtual meeting room may be needed for the meeting. If the anticipatory meeting server 20 determines that the meeting requires a physical meeting between the participants, the anticipatory meeting server 20, at step 230, determines that this is a physical meeting and requires a physical meeting room. At step 232, the anticipatory meeting server 20 may then use the find room method, as described previously in connection with FIG. 4. At step 234, the anticipatory meeting server 20 may then send directions to the selected meeting room to the user devices 60, 62, 64 of the participants of the meeting.

However, if the anticipatory meeting server 20, at step 220, determines that the meeting does not require a physical meeting between the participants, or determines that a physical meeting is not possible, the anticipatory meeting server 20, at step 240, then determines that this is a virtual meeting. At step 250, the anticipatory meeting server 20 may then determine if the virtual meeting requires a virtual meeting room. If the server determines that a virtual meeting room is required, then, at step 252, the anticipatory meeting server 20 may then use the find room method, as described previously in connection with FIG. 4. Conversely, if the anticipatory meeting server 20 determines that a virtual meeting room is not required for this virtual meeting, then, at step 254, the anticipatory meeting server 20 does not schedule any type of meeting room and the method ends.

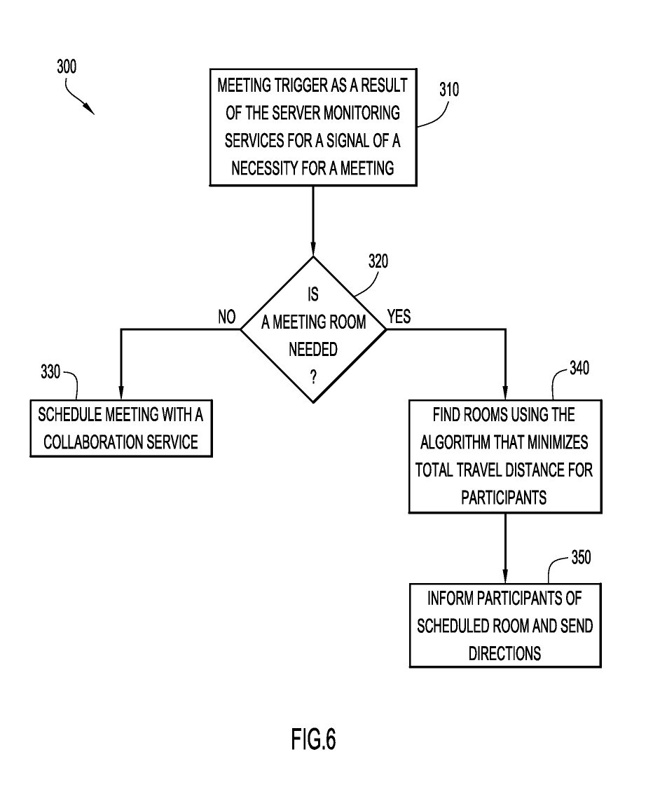

Turning to FIG. 6, illustrated is a flow diagram of a method for scheduling a meeting room for an impromptu meeting by the anticipatory meeting server 20 of the anticipatory meeting scheduling system 10. Unlike the previous example, where the meeting trigger for was a meeting reminder for a previously scheduled meeting, in the example embodiment illustrated in FIG. 6, the anticipatory meeting server 20 is monitoring various services used by users of the anticipatory meeting scheduling system 10 (i.e., scheduling services, email services, instant messaging services, etc.) for language, information, or any other indication that can be interpreted as a signal for a necessity for a meeting. As explained previously the user devices 60, 62, 64 may be capable of operating scheduling services, email services, instant messaging services, etc., and the anticipatory meeting server 20 may be configured to monitor over network 80 either the operation of these services on the user devices 60, 62, 64, or the servers 70, 72, 74, as illustrated in FIG. 1, that provide these services to the user devices 60, 62, 64. The anticipatory meeting server 20 may interpret text, data, or other types of indications from the various services as a signal for a necessity for a meeting. For example, if one user sends to another user via an instant messaging service a message that says “Let's meet at 1 PM,” the anticipatory meeting server 20, which is monitoring the instant message service of the users, will interpret this as a meeting trigger, and will begin the process 300 of scheduling a meeting for the participants.

As illustrated in FIG. 6, at step 310, the anticipatory meeting server 20 receives a meeting trigger, which is in response to the anticipatory meeting server 20 monitoring various services for signal that indicates the need for, or the attempt to schedule, a meeting between users. Once the anticipatory meeting server 20 receives a meeting trigger, the anticipatory meeting server 20, at step 320, then determines if a meeting room is needed for this meeting. In addition to the anticipatory meeting server 20 monitoring the user devices 60, 62, 64 of the participants, the anticipatory meeting server 20 may also monitor a user's location via Wi-Fi based location services, location metadata in messages being sent between participants, etc. If the anticipatory meeting server 20 determines that the users of the meeting are in close enough proximity to one another, then the anticipatory meeting server 20 may determine at step 320 that a meeting room is needed. If the anticipatory meeting server 20 determines that the participants of the meeting are not located close enough in proximity to one another, then the anticipatory meeting server 20 may determine at step 320 that a meeting room is not needed. If the anticipatory meeting server 20 determines that a meeting room is not needed at step 320, then, at step 330, the anticipatory meeting server 20 may schedule a meeting between the participants with an online/web-based service.

However, if the anticipatory meeting server 20 determines that a meeting room is needed at step 320, then, at step 340, the anticipatory meeting server 20 then uses the find room method, as explained previously in connection with FIG. 4, to find and schedule a meeting room that minimizes the total travel distance of all of the participants of the meeting. Once the anticipatory meeting server 20 determines the most suitable meeting room for the meeting, the anticipatory meeting server 20 then, at step 350, informs the participants of the scheduled meeting room and sends to user devices 60, 62, 64 of each of the participants of the meeting directions on how to get from their current location to the scheduled meeting room.

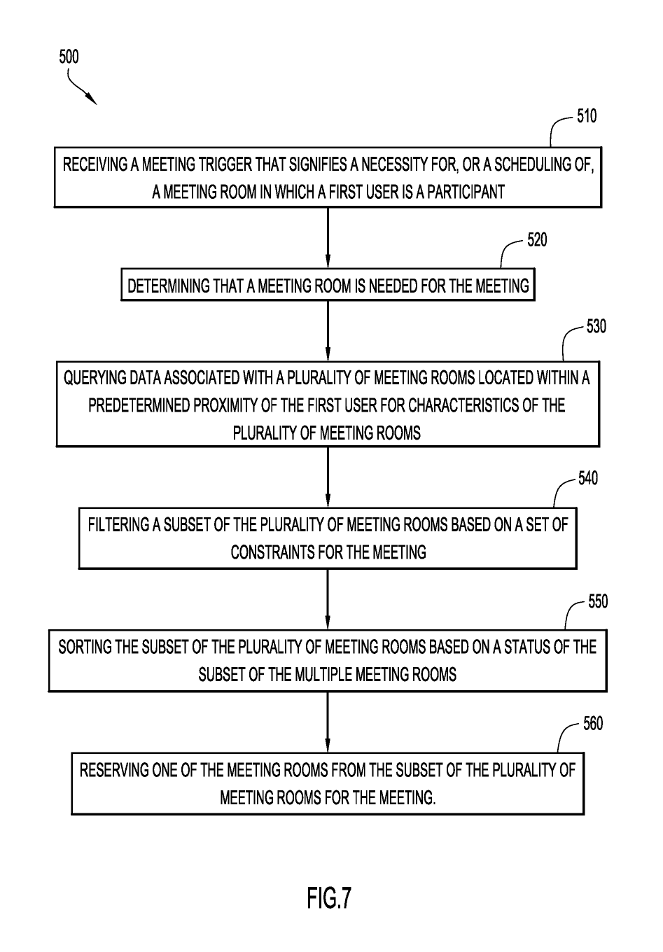

An example embodiment of a high-level process 500 performed by the anticipatory meeting server 20 for scheduling meeting rooms 40, 50 is depicted in the flowchart of FIG. 7. Reference is also made to FIGS. 1-6 for purposes of the description of FIG. 7. At 510, the anticipatory meeting server 20 receives a meeting trigger that signifies the necessity for, or the scheduling of, a meeting in which a first user is a participant. The meeting trigger may be in relation to a meeting reminder being sent or displayed to the participants of the meeting, as illustrated in the example embodiment of FIG. 5, or may be in relation to the server monitoring various messaging services, as illustrated in the example embodiment of FIG. 6. At 520, the anticipatory meeting server 20 may then determine that a meeting room is needed for the meeting. As explained previously, the meeting trigger may contain data that signifies when a meeting room is required, and if so, what type of meeting room (i.e., physical or virtual) is needed for the meeting. Upon determining that a meeting room is needed by the anticipatory meeting server 20, at 530, the anticipatory meeting server 20 then queries data associated with the plurality of meeting rooms which are located within a predetermined proximity of the first user, for characteristics of the plurality of meeting rooms. As previously explained, these characteristics may include, but are not limited to, video conferencing capabilities, telephone conferencing capabilities, wireless network capabilities, size of the room, proximity of the room, etc.

Once all of the meeting rooms have been queried for their characteristics, the anticipatory meeting server 20, at step 540, filters the plurality of meeting rooms into a subset of the plurality of meeting rooms based on a set of constraints for the meeting. The meeting trigger may include information or data about the constraints or requirements for the meeting, such as, but not limited to, a requirement for video conferencing, a requirement for telephone conferencing, a requirement for wireless network connectivity (e.g., Wi-Fi) and/or the ability to connect to the network 80, the number of chairs needed in the room, the number of tables needed in the room, the proximity of the room in relation to the participants, etc. At step 550, the anticipatory meeting server 20 then sorts the subset of the meeting rooms by the meeting room usage state priority, where meeting rooms may have a usage state of unscheduled and unoccupied 460, unscheduled and occupied 450, scheduled and unoccupied 440, and scheduled and occupied 430. As previously explained, the meeting room usage state, in order of most preferred to least preferred, is unscheduled and unoccupied 460, unscheduled and occupied 450, scheduled and unoccupied 440, and scheduled and occupied 430. Finally, at step 560, the anticipatory meeting server 20 reserves one of the meeting rooms from the subset of the plurality of meeting rooms for the meeting, where the selected meeting room is the meeting room that is most preferred and contains the characteristics that fit the constraints of the meeting. Thus, the scheduled meeting room is the meeting room that is most suitable for the participants of the meeting.

When the anticipatory meeting server 20 sorts the subset of the plurality of meeting rooms based on a usage state (e.g., usage states 430, 440, 450, and 460) of the subset of the plurality of meeting rooms, the anticipatory meeting server 20 determines which meeting rooms of the subset of the plurality of meeting rooms are currently scheduled via a scheduling service, and which meeting rooms of the subset of the plurality of meeting rooms are currently occupied. When the anticipatory meeting server 20 determines which of the meeting rooms are currently occupied, the anticipatory meeting server 20 analyzes data that is output from the sensors located in or proximate the meeting rooms or capable or obtaining information about occupancy of the meeting rooms even if the sensors (such as power usage sensors) are remote from the meeting room. For example, the anticipatory meeting server 20 may analyze the output of a motion sensor in a meeting room , the wireless local area network activity in a meeting room, energy usage in a meeting room, phone usage in a meeting room, the video usage in a meeting room, etc. Once a meeting room 40, 50 has been booked by the anticipatory meeting server 20, the anticipatory meeting server 20 may then send a message to the user devices 60, 62, 64, where the message may contain directions to the scheduled meeting room.

As explained above, meetings are often scheduled, and meeting rooms are often reserved using scheduling or calendaring services. However, meeting rooms are often scheduled or reserved and then never used. Moreover, groups of people often use a meeting room without ever going through the proper procedures for reserving the meeting room, causing confusion and conflicts between groups of people who actually scheduled the meeting room via the scheduling or calendaring services.

The techniques presented herein provide a computer-implemented method of monitoring a user's messaging services to determine when the user will need a meeting room for a meeting with other users, and then reserving the best suited meeting room for the meeting without the user ever requesting that the meeting room be reserved. As described herein, the server not only monitors a user's devices, but also monitors the meeting rooms themselves, along with the locations of the participants in relation to the meeting rooms and each other. The server is able to determine which meeting rooms are currently scheduled, which meeting rooms are currently occupied, the technological capabilities of each of the meeting rooms, and which meeting rooms are in a certain proximity to the indicated participants of the meeting. The server is able to determine, based on the characteristics of each of the meeting rooms, the scheduling status of the meeting rooms, the occupancy status of the meeting rooms, and the proximity of the meeting rooms to the indicated participants to filter the plurality of meeting rooms, and then sort the meeting rooms into an order of most preferred to least preferred meeting rooms. The server can then reserve the best suited meeting room for the indicated participants and the constraints of the meeting, where the server then provides each of the participants with directions to the reserved meeting room.

The techniques presented herein may be used by a server of an anticipatory meeting scheduling system to reduce both the confusion of scheduling meeting rooms and the time required to determine which meeting room is best suited for the meeting. The anticipatory meeting scheduling system prevents situations where one group of participants is holding a meeting in a meeting room that has been scheduled for another group of participants. Moreover, the anticipatory meeting scheduling system prevents users from scheduling meeting rooms and monopolizing meeting rooms, when those participants do not need the meeting room. In addition, the anticipatory meeting scheduling system prevents participants from scheduling meeting rooms that are best suited for that participant, but is an inconvenience for the other participants of the meeting.

The above description is intended by way of example only. Various modifications and structural changes may be made therein without departing from the scope of the concepts described herein and within the scope and range of equivalents of the claims.

What is claimed is:

1. A computer-implemented method comprising:
at a server in communication with user devices, receiving a meeting trigger that signifies a necessity for a meeting, or scheduling of the meeting, in which a first user is a participant;
determining that a meeting room is needed for the meeting;
upon determining that a meeting room is needed for the meeting, querying data associated with a plurality of meeting rooms located within a predetermined proximity of the first user for characteristics of the plurality of meeting rooms;
filtering a subset of the plurality of meeting rooms based on a set of constraints for the meeting;
sorting the subset of the plurality of meeting rooms based on a usage state of the subset of the plurality of meeting rooms; and
reserving one of the meeting rooms from the subset of the plurality of meeting rooms for the meeting.

2. The method of claim 1, wherein sorting the subset of the plurality of meeting rooms based on a usage state of the subset of the plurality of meeting rooms further comprises:
determining which one or more meeting rooms of the subset of the plurality of meeting rooms is currently scheduled and which one or more meeting rooms of the subset of the plurality of meeting rooms is currently occupied.

3. The method of claim 2, wherein determining which one or more meeting rooms is currently occupied comprises analyzing data from one or more of: an output of a motion sensor in a meeting room, wireless local area network activity in a meeting room, energy usage in a meeting room, phone usage in a meeting room, or video usage in a meeting room.

4. The method of claim 2, wherein determining comprises determining the usage state of a meeting room as being one of: unscheduled and unoccupied, unscheduled and occupied, scheduled and unoccupied, or scheduled and occupied.

5. The method of claim 1, further comprising:
sending to the first user a message containing directions to a scheduled meeting room.

6. The method of claim 1, wherein filtering a subset of the plurality of meeting rooms based on a set of constraints for the meeting based on size of a meeting room, equipment available in a meeting room, and total travel distance of the first user to a meeting room.

7. The method of claim 1, wherein the meeting trigger is received by the server from a user device of the first user associated with a meeting reminder or from a service entity that generates meeting reminders.

8. An apparatus comprising:
a network interface unit configured to enable communications over a network with user devices; and
a processor configured to:
receive a meeting trigger that signifies a necessity for a meeting, or scheduling of the meeting, in which a first user is a participant;
determine that a meeting room is needed for the meeting;
upon determining that a meeting room is needed for the meeting, query data associated with a plurality of meeting rooms located within a predetermined proximity of the first user for characteristics of the plurality of meeting rooms;
filter a subset of the plurality of meeting rooms based on a set of constraints for the meeting;
sort the subset of the plurality of meeting rooms based on a usage state of the subset of the plurality of meeting rooms; and
reserve one of the meeting rooms from the subset of the plurality of meeting rooms for the meeting.

9. The apparatus of claim 8, wherein the processor is configured to sort the subset of the plurality of meeting rooms based on a usage state of the subset of the plurality of meeting rooms, and the processor being configured to:
determine which one or more meeting rooms of the subset of the plurality of meeting rooms is currently scheduled and which one or more meeting rooms of the subset of the plurality of meeting rooms is currently occupied.

10. The apparatus of claim 9, wherein the processor is configured to determine which one or more meeting rooms is currently occupied by analyzing one or more of: data from an output of a motion sensor in a meeting room, wireless local area network activity in a meeting room, energy usage in a meeting room, phone usage in a meeting room, or video usage in a meeting room.

11. The apparatus of claim 9, wherein the processor is configured to determine the usage state of a meeting room as being one of: unscheduled and unoccupied, unscheduled and occupied, scheduled and unoccupied, or scheduled and occupied.

12. The apparatus of claim 8, the processor is further configured to:
send to the first user a message containing directions to a scheduled meeting room.

13. The apparatus of claim 8, wherein the processor is configured to filter a subset of the plurality of meeting rooms based on a set of constraints for the meeting based on size of a meeting room, equipment available in a meeting room, and total travel distance of the first user to a meeting room.

14. The apparatus of claim 8, wherein the meeting trigger is received by the server from a user device of the first user associated with a meeting reminder or from a service entity that generates meeting reminders.

15. One or more computer readable storage media encoded with software comprising computer executable instructions, and when the software is executed, operable to:
receive a meeting trigger that signifies a necessity for a meeting, or the scheduling of a meeting, in which a first user is a participant;
determine that a meeting room is needed for the meeting;
upon determining that a meeting room is needed for the meeting, query data associated with a plurality of meeting rooms located within a predetermined proximity of the first user for characteristics of the plurality of meeting rooms;
filter a subset of the plurality of meeting rooms based on a set of constraints for the meeting;
sort the subset of the plurality of meeting rooms based on a usage state of the subset of the plurality of meeting rooms; and
reserve one of the meeting rooms from the subset of the plurality of meeting rooms for the meeting.

16. The computer readable storage media of claim 15, wherein the instructions operable to sort comprise instructions operable to:
determine which one or more meeting rooms of the subset of the plurality of meeting rooms is currently scheduled and which one or more meeting rooms of the subset of the plurality of meeting rooms is currently occupied.

17. The computer readable storage media of claim 16, wherein the instructions operable to determine which one or more meeting rooms is currently occupied further comprise instructions operable to analyze one or more of: data from an output of a motion sensor in a meeting room, wireless local area network activity in a meeting room, energy usage in a meeting room, phone usage in a meeting room, or video usage in a meeting room.

18. The computer readable storage media of claim 16, further comprising instructions operable to determine the state of a meeting room as being one of: unscheduled and unoccupied, unscheduled and occupied, scheduled and unoccupied, or scheduled and occupied.

19. The computer readable storage media of claim 15, further comprising instructions operable to:
send to the first user a message containing directions to a scheduled meeting room.

20. The computer readable storage media of claim 15, wherein the instructions operable to filter comprise the instructions operable to:
filter a subset of the plurality of meeting rooms based on size of a meeting room, equipment available in a meeting room, and total travel distance of the first user to a meeting room.
